(19) United States
(12) Patent Application Publication
(10) Pub. No.: US 2010/0270295 A1
(43) Pub. Date: Oct. 28, 2010

(54) SCOPES HEATING DEVICE

(76) Inventor: Ching-Chuan WANG, Yung-Ho City (TW)

Correspondence Address: Guice Patents PLLC, 12647 Galveston Court #302, Manassas, VA, 20112, US

(21) Appl. No.: 12/508,561

(22) Filed: Jul. 23, 2009

(30) Foreign Application Priority Data
Apr. 27, 2009 (TW) 098207044

(51) Int. Cl. H05B 6/64

(52) U.S. Cl. 219/756

(57) ABSTRACT

A scopes heating device includes a bag having first seal lines that divides the bag into a first chamber at one side and a second chamber at an opposite side, a heat storage/release material accommodated in the bag and flowing between the first chamber and the second chamber for storing/releasing heat energy, a fixation device mounted on the bag for securing the bag in a folded condition where the first chamber and the second chamber are stacked up, and an actuator bendable to generate microwaves for causing the heat storage/release material to produce a temperature rise and then to release heat for pre-heating scopes that are set between the first chamber and the second chamber after the bag having been folded up.

### BACKGROUND OF THE INVENTION

1. Field of the Invention

The present invention relates to means for pre-heating scopes and more particularly, to a scopes heating device based on the technical features of U.S. Pat. No. 5,025,278. The scopes heating device uses a fixation device to hold the bag in the folded condition to pre-heat scopes efficiently.

2. Description of the Related Art

Heat storage/release devices are known for years for use to keep the body warm or for the purpose of cold compress. There are many methods to prepare heat storage/release devices. Conventionally, a water bladder may be used to hold hot water for keeping the body warm. There is also known a hot compress bag that comprises a bag body filled with a fluid and sealed, and a metal actuator strip mounted in the bag body and operable to actuate the fluid, causing a chemical reaction and release of heat. During heat producing and releasing procedure, the hot compress bag provides heat energy for hot compress application. U.S. Pat. No. 5,025,278, issued to the present inventor, discloses a similar design, entitled “Heat storage/release device for hot/cold compress application”, which comprises a bag, which defines therein a sealed accommodation chamber, a heat storage/release material, which is accommodated in the accommodation chamber of the bag and adapted for storing/releasing heat energy, and flexible members fastened to the bag at two opposite sides relative to the accommodation chamber and bendable to hold the bag in a predetermined shape and to secure the bag to a person's face.

Further, following fast development of technology, many scopes have been created and are intensively used to look inside a body cavity or organ. Before application, the scopes must be pre-heated, performing primary sterilization and reducing patient's discomfort.

Nowadays, steam heaters and heat storage/release devices are commonly used for pre-heating scopes. FIG. 1 illustrates scopes set in a prior art scope heating device. According to this prior design, the scope heating device comprises a bag 100 that has at least one seal line 110 that divides the inside space of the bag into a first space 120 at one side and a second space 130 at the opposite side, a heat storage/release material 140 mounted inside the bag 100, and an actuator 150 that is bendable to generate microwaves for causing the heat storage/release material 140 to produce a temperature rise and then to release heat so as to pre-heat the scopes 160 that are respectively attached to the first space 120 and the second space 130.

The aforesaid prior art scope heating device is still not satisfactory in function because of the following drawbacks:

1. During application, the scope heating device is folded up, and two scopes 160 to be pre-heated are respectively set in the first space 120 and the second space 130, and then an adhesive tape 170 or towel (not shown) is used to wrap the folded scope heating device. This application procedure is complicated. Further, residual substance will be left on the bag 100 after removal of the adhesive tape 170, causing contamination and resulting in a bad looking.

2. The bag 100 uses longitudinal seal lines 110 to divide the first space 120 and the second space 130. When the bag 100 is folded up, the scopes 160 are not fully kept in contact with the corresponding lateral side of the first space 120 or the second space 130, affecting scope heating velocity.

Therefore, there is need for a scopes heating device that eliminates the aforesaid drawbacks.

### SUMMARY OF THE INVENTION

The present invention has been accomplished under the circumstances in view. It is one object of the present invention to provide a scopes heating device, which uses a fixation device to hold scopes in place for pre-heating efficiently.

It is another object of the present invention to provide a scopes heating device, which has at least one first seal line and at least one second seal line formed in the heat storage/release material accommodation bag thereof to divide the bag into a first chamber, a second chamber and a third chamber so that the scopes to be heated are kept in fully contact with the first chamber, the second chamber and the third chamber for pre-heating efficiently.

To achieve these and other objects of the present invention, a scopes heating device comprises a bag, a heat storage/release material, a fixation device and an actuator. The bag has at least one first seal line that divides the bag into a first chamber at one side relative to the at least one first seal line and a second chamber at an opposite side relative to the at least one first seal line. The heat storage/release material is accommodated in the bag and flowing between the first chamber and the second chamber and adapted for storing/releasing heat energy. The fixation device is mounted on the bag, and adapted to secure the bag in a folded condition where the first chamber and the second chamber are stacked up. The actuator is formed of a metal strip and mounted in the bag. The actuator is bendable to generate microwaves for causing the heat storage/release material to produce a temperature rise and then to release heat for pre-heating scopes that are set between the first chamber and the second chamber after the bag having been folded up.

### BRIEF DESCRIPTION OF THE DRAWINGS

FIG. 1 is a schematic drawing showing two scopes set in a folded scopes heating device according to the prior art.

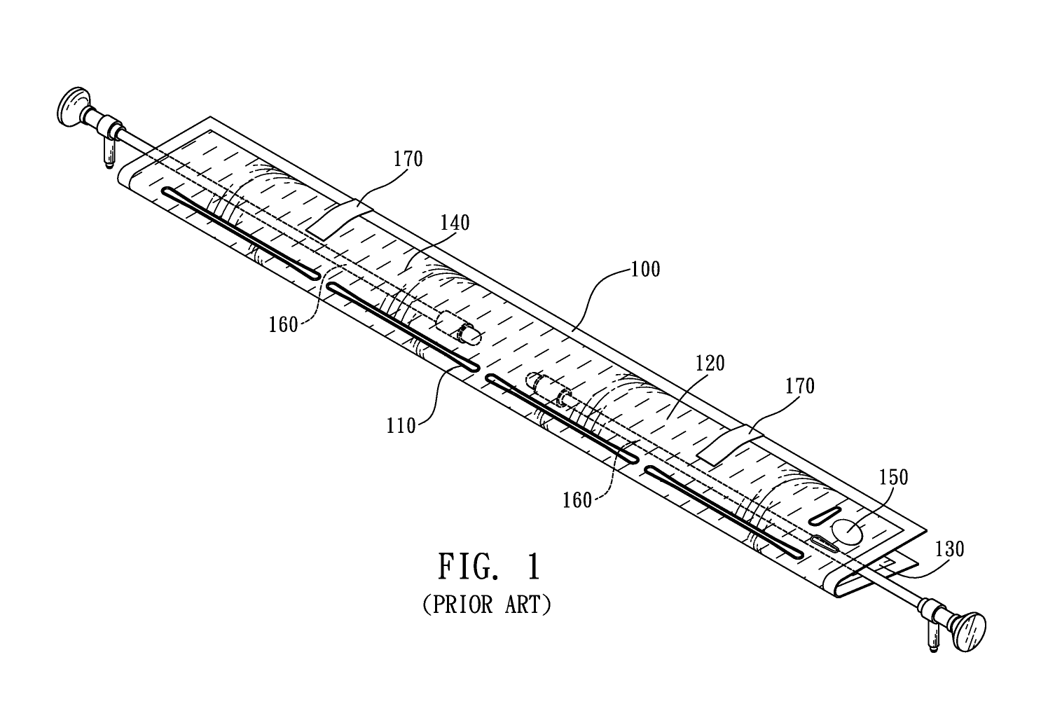

FIG. 2 is an extended view of a scopes heating device according to the present invention.

FIG. 3 is a schematic drawing of the present invention, showing the scopes heating device folded up and scopes set in the folded scopes heating device.

FIG. 4 is an extended view of an alternate form of the scopes heating device according to the present invention.

FIG. 5 is a schematic drawing of the alternate form of the present invention, showing the scopes heating device folded up and scopes set in the folded scopes heating device.

### DETAILED DESCRIPTION OF THE PREFERRED EMBODIMENT

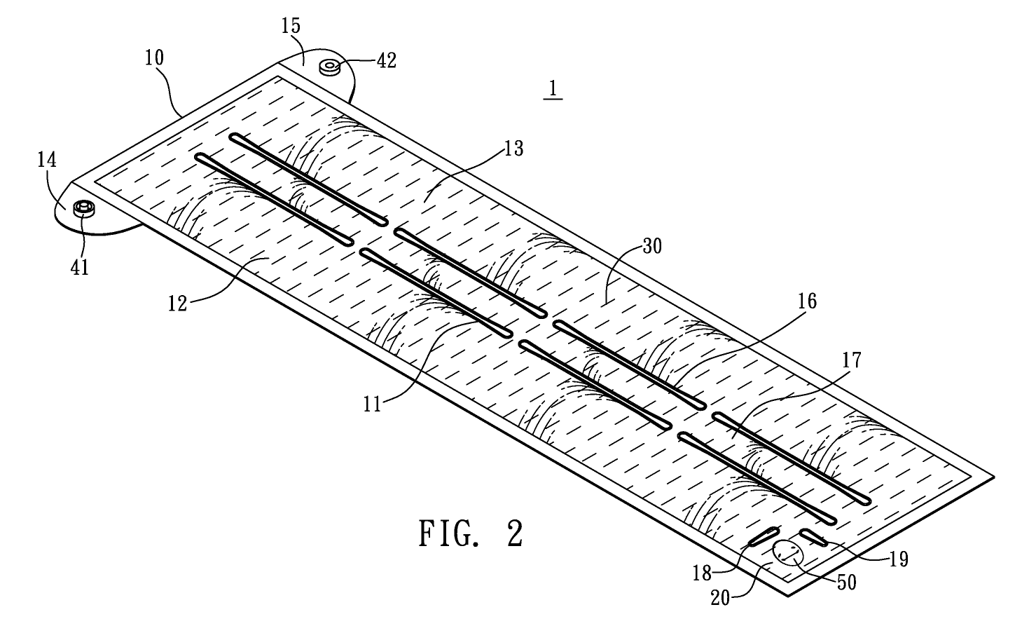

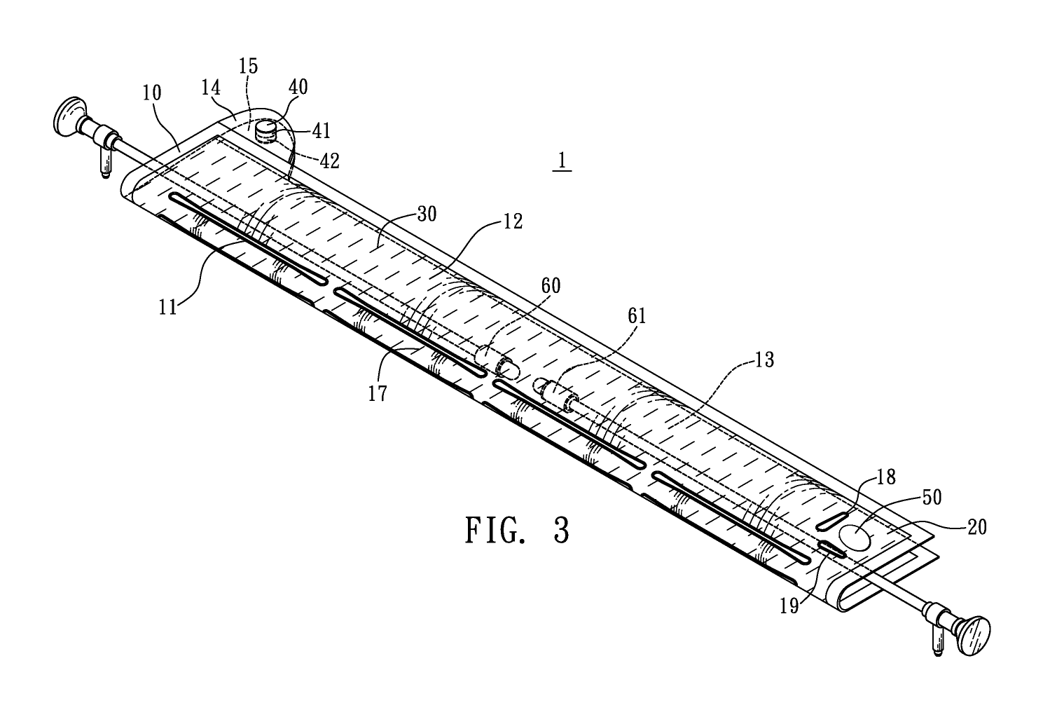

Referring to FIGS. 2 and 3, a scopes heating device 1 in accordance with the present invention is shown comprising a bag 10, a heat storage/release material 30, a fixation device 40 and an actuator 50.

The bag 10 has a predetermined shape, for example, but not limited to, rectangular shape. According to this embodiment, the bag 10 has at least one, for example, but not limited to, four first seal lines 11 longitudinally aligned in line and dividing the inside space of the bag into a first chamber 12 at one side and a second chamber 13 at an opposite side for accommodating the heat storage/release material 30. The bag 10 is made of, but not limited to, polymeric material. Further, the bag 10 is preferably a transparent bag. For the purpose of being reusable, the material of the bag 10 has durable and extensible characteristics and a certain thickness. During fabrication, high frequency sealing technique or any other suitable sealing technique is employed to seal the periphery of the bag 10. This bag fabrication method is of the known art and not within the scope of the claims of the present invention, and therefore no further detailed description in this regard is necessary.

The heat storage/release material 30 has the power of storing/releasing heat energy, and is accommodated in the bag 10. The heat storage/release material 30 can be pure water, saturated sodium acetate solution, or any suitable known fluid that releases heat gradually after having been heated. Further, the heat storage/release material can be stored in a refrigerator (not shown).

The fixation device 40 is mounted on the bag 10 for securing the first chamber 12 and the second chamber 13 in a stacked manner when the bag 10 is folded up. As illustrated, the fixation device 40 comprises a first fastening member 41 and a second fastening member 42. The first fastening member 41 is, for example, a male fastening member provided at the top side of the first chamber 12. The second fastening member 42 is, for example, a female fastening member provided at the top side of the second chamber 13 and connectable to the first fastening member 41.

The bag 10 further has two flaps 14 and 15 respectively extended from two sides of one end thereof for carrying the first fastening member 41 and the second fastening member 42 respectively. The flaps 14 and 15 are fixedly fastened to the border of the bag 10 by means of, for example, but not limited to, a high-frequency heat sealing technique.

The bag 10 further has at least one, for example, but not limited to, four second seal lines 16 longitudinally aligned in line and disposed in a parallel manner relative to the first seal lines 11, thereby defining a third chamber 17 between the first seal lines 11 and the second seal lines 16. Further, the heat storage/release material 30 is flowing among the first chamber 12, the second chamber 13 and the third chamber 17. Further, the first seal lines 11 and the second seal lines 16 can be produced by means of a high-frequency heat sealing technique.

The bag 10 further has a third seal line 18 and a fourth seal line 19 disposed at right angles around one corner thereof remote from the flaps 14 and 15, defining a fourth chamber 20 for accommodating the actuator 50. The third seal line 18 and the fourth seal line 19 are made by means of a high-frequency heat sealing technique.

The actuator 50 is mounted in the fourth chamber 20 of the bag 10. Further, the actuator 50 is, for example, but not limited to, a metal strip that is bendable to generate microwaves for causing the heat storage/release material 30 to produce a temperature rise and then to release heat. With respect to this temperature rise and heat release function, please refer to the description of U.S. Pat. No. 5,025,278.

Referring to FIG. 3, during application of the scopes heating device 1, attach the two scopes 60 and 61 to be warmed up to the bag 10 corresponding to the third chamber 17, and then fold up the bag 10 to let the two scopes 60 and 61 be surrounded by the third chamber 17, the first chamber 12 and the second chamber 13, and then fasten the first fastening member 41 at the first chamber 12 to the second fastening member 42 at the second chamber 13 to secure the bag 10 in the folded condition and to keep the two scopes 60 and 61 in fully contact with the third chamber 17, the first chamber 12 and the second chamber 13, and finally bend the actuator 50 to generate microwaves that cause the heat storage/release material 30 to produce a temperature rise and to further release heat, thereby pre-heating the scopes 60 and 61. Thus, the scopes heating device 1 improves the drawbacks of the prior art design.

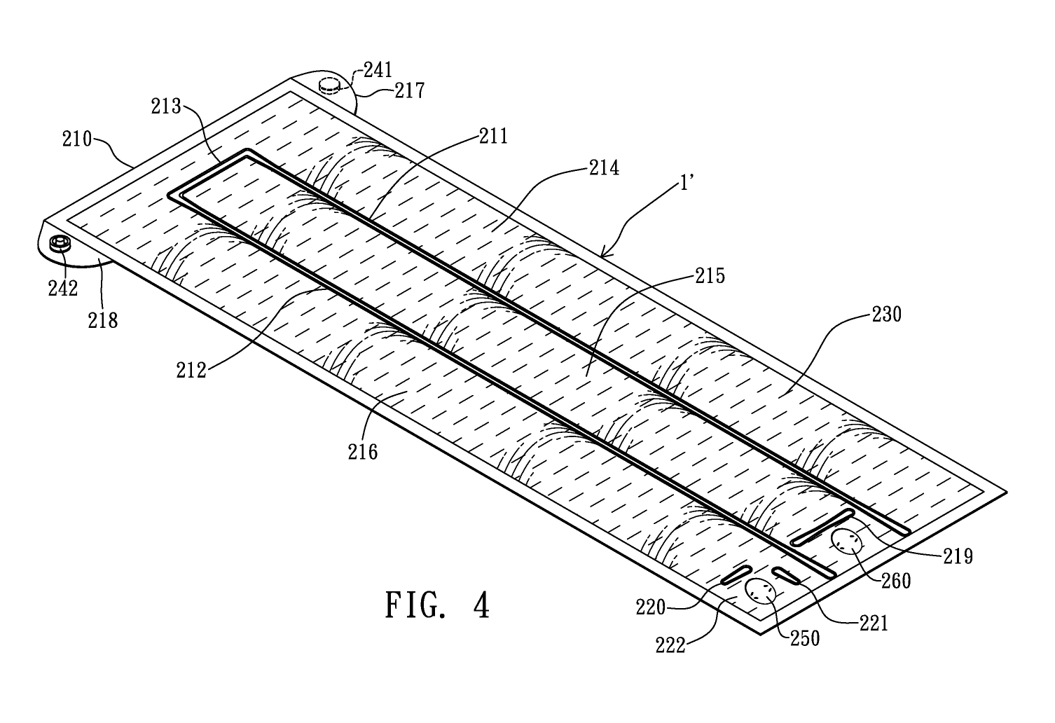

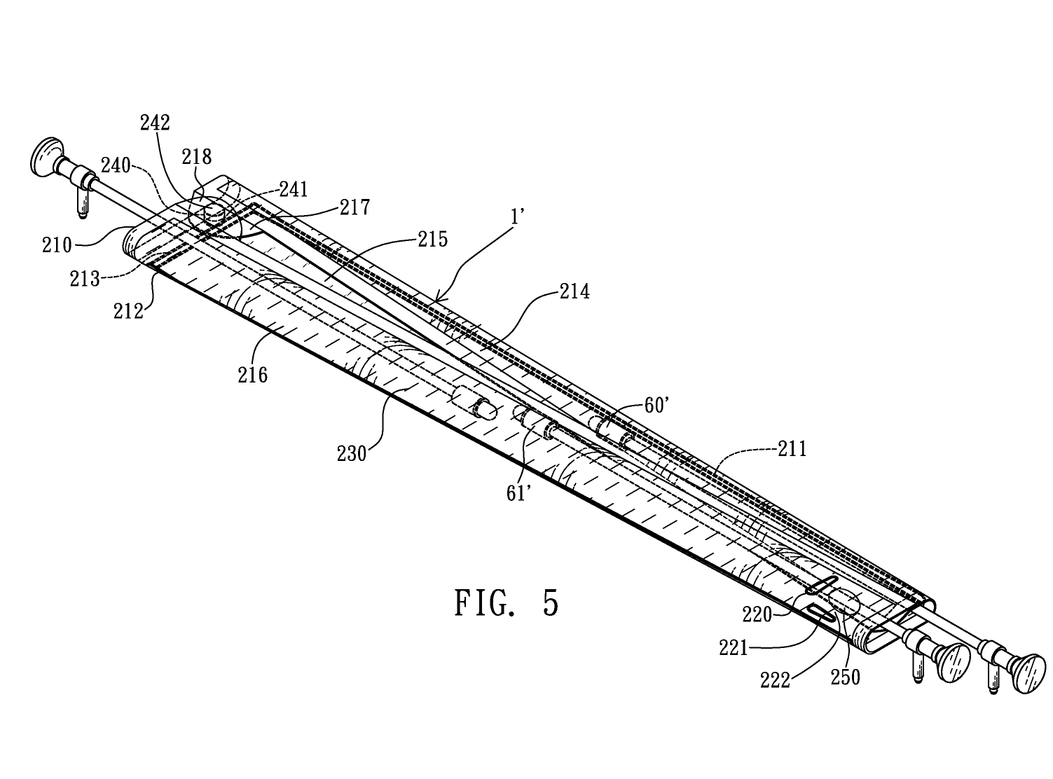

FIGS. 4 and 5 show an alternate form of the present invention. According to this alternate form, the scopes heating device 1′ comprises a bag 210, a heat storage/release material 230, a fixation device 240, a first actuator 250 and a second actuator 260.

The bag 210 has a predetermined shape, for example, but not limited to, rectangular shape. According to this alternate form, the bag 210 has a first seal line 211 and a second seal line 212 longitudinally arranged in parallel, a third seal line 213 transversely connected between one end of the first seal line 211 and the corresponding end of the second seal line 212, a first chamber 214 defined therein at one lateral side relative to the first seal line 211, a second chamber 215 defined between the first seal line 211 and the second seal line 212, and a third chamber 216 defined therein at one lateral side relative to the second seal line 212. The first chamber 214, the second chamber 215 and the third chamber 216 accommodate the heat storage/release material 230. The first chamber 214 and the third chamber 216 are in fluid communication with each other and isolated from the second chamber 215. The bag 210 is made of, but not limited to, polymeric material. Further, the bag 210 is preferably a transparent bag. For the purpose of being reusable, the material of the bag 210 has durable and extensible characteristics and a certain thickness. During fabrication, high frequency sealing technique or any other suitable sealing technique is employed to seal the periphery of the bag 210. This bag fabrication method is of the known art and not within the scope of the claims of the present invention, and therefore no further detailed description in this regard is necessary.

The heat storage/release material 230 has the power of storing/releasing heat energy, and is accommodated in the chambers 214-216 of the bag 210. The heat storage/release material 230 can be pure water, saturated sodium acetate solution, or any suitable known fluid that releases heat gradually after having been heated. Further, the heat storage/release material can be stored in a refrigerator (not shown).

The fixation device 240 is mounted on the bag 210 for securing the first chamber 214 and the third chamber 216 in a stacked manner when the bag 210 is folded up. As illustrated, the fixation device 240 comprises a first fastening member 241 and a second fastening member 242. The first fastening member 241 is, for example, a male fastening member provided at the top side of the first chamber 214. The second fastening member 242 is, for example, a female fastening member provided at the top side of the third chamber 216 and connectable to the first fastening member 241.

The bag 210 further has two flaps 217 and 218 respectively extended from two sides of one end thereof for carrying the first fastening member 241 and the second fastening member 242 respectively. The flaps 217 and 218 are fixedly fastened to the border of the bag 210 by means of, for example, but not limited to, a high-frequency heat sealing technique.

The bag 210 further has a fourth seal line 219 spaced between the spaced between the first seal line 211 and the second seal line 212 near the other end remote from the third seal line 213 defining a space for accommodating the second actuator 260. The fourth seal line 219 is made by means of a high-frequency heat sealing technique.

The bag 210 further has a fifth seal line 220 and a sixth seal line 221 disposed at right angles around one corner of the third chamber 216, defining a fourth chamber 222 for accommodating the first actuator 250. The fifth seal line 220 and a sixth seal line 221 are made by means of a high-frequency heat sealing technique.

The first actuator 250 is accommodated in the fourth chamber 222 inside the bag 210. Further, the first actuator 250 is, for example, but not limited to, a metal strip that is bendable to generate microwaves for causing the heat storage/release material 230 to produce a temperature rise and then to release heat. With respect to this temperature rise and heat release function, please refer to the description of U.S. Pat. No. 5,025,278.

The second actuator 260 is accommodated in one end of the second chamber 215 at one side relative to the fourth seal line 219. Further, the second actuator 260 is, for example, but not limited to, a metal strip that is bendable to generate microwaves for causing the heat storage/release material 230 to produce a temperature rise and then to release heat. With respect to this temperature rise and heat release function, please refer to the description of U.S. Pat. No. 5,025,278.

Referring to FIG. 5, during application of the scopes heating device 1′, attach a first scope 60′ to be warmed up to the bag 210 corresponding to the second chamber 215, and then fold up one lateral side of the bag 210 to have the folded part of the bag 210 be covered on the first scope 60′, and then attach a second scope 61′ to be warmed up to the bag 210 corresponding to the first chamber 214, and then fold up the other lateral side of the bag 210 to have the part of the bag 210 corresponding to the third chamber 216 be covered on the second scope 61′, and then fasten the first fastening member 241 at the first chamber 214 to the second fastening member 242 at the third chamber 216 to secure the bag 210 in the folded condition and to keep the two scopes 60′ and 61′ in fully contact with the third chamber 216, the first chamber 214 and the second chamber 215, and finally bend the first actuator 250 to generate microwaves that cause the heat storage/release material 230 to produce a temperature rise and to further release heat, thereby pre-heating the scopes 60′ and 61′. If the operation time must be extended, bend the second actuator 260 to generate microwaves that cause the heat storage/release material 230 to produce a temperature rise and to further release heat, thereby continuously warming up the scopes 60′ and 61′. Thus, the scopes heating device 1′ improves the drawbacks of the prior art design.

As stated above, the scopes heating device is provided with a fixation that holds the bag of the scopes heating device in a folded condition to keep scopes in fully contact with the bag for pre-heating positively. Further, the bag of the scopes heating device has at least one first seal line and at least one second seal line to divide the inside space of the bag into a first chamber, a second chamber and a third chamber. Thus, when the bag is folded up, these three chambers are kept in contact with the scopes to be pre-heated, enabling the scopes to be quickly pre-heated. Therefore, the invention effectively improves the drawbacks of the prior art design.

A prototype of scopes heating device has been constructed with the features of FIGS. 2 and 3. The scopes heating device functions smoothly to provide all of the features disclosed earlier.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A scopes heating device for pre-heating scopes, comprising:
a bag, said bag having at least one first seal line that divides said bag into a first chamber at one side relative to said at least one first seal line and a second chamber at an opposite side relative to said at least one first seal line;
a heat storage/release material accommodated in said bag and flowing between said first chamber and said second chamber and adapted for storing/releasing heat energy;
a fixation device mounted on said bag and adapted to secure said bag in a folded condition where said first chamber and said second chamber are stacked up; and
an actuator formed of a metal strip and mounted in said bag and bendable to generate microwaves for causing said heat storage/release material to produce a temperature rise and then to release heat for pre-heating scopes being set between said first chamber and said second chamber after said bag having been folded up.

2. The scopes heating device as claimed in claim 1, wherein said heat storage/release material is saturated sodium acetate solution.

3. The scopes heating device as claimed in claim 1, wherein said bag is made of a polymeric material.

4. The scopes heating device as claimed in claim 1, wherein said fixation device comprises:
a first fastening member provided at said bag corresponding to said first chamber; and
a second fastening member provided at said bag corresponding to said second chamber and fastenable to said first fastening member.

5. The scopes heating device as claimed in claim 4, wherein said first fastening member is a male fastening member, and said second fastening member is a female fastening member.

6. The scopes heating device as claimed in claim 5, wherein said bas has a first flap and a second flap respectively protruded from two opposite sides of one end thereof, said first fastening member and said second fastening member are respectively located on said first flap and said second flap.

7. The scopes heating device as claimed in claim 1, wherein said at least one seal line is longitudinally located on a middle part of said bag.

8. The scopes heating device as claimed in claim 7, wherein said bag further has at least one second seal line disposed at one lateral side relative to said at least one first seal line and defining a third chamber in fluid communication between said first chamber and said second chamber.

9. The scopes heating device as claimed in claim 8, wherein said at least one first seal line, said at least one second seal line and said flaps are made by means of a high-frequency heat sealing technique.

10. The scopes heating device as claimed in claim 8, wherein said bag further has a third seal line and a fourth seal line arranged at right angles around one corner thereof remote from said fixation device and defining a third chamber in said bag for accommodating said actuator; said third seal line and said fourth seal line are formed by means of a high-frequency heat sealing technique.

11. A scopes heating device for pre-heating scopes, comprising:
a bag, said bag having a first seal line, a second seal line, a third seal line, a first chamber defined at one side of said first seal line opposite to said second seal line, a second chamber defined between said first seal line and said second seal line, a third chamber defined at one side relative to said second seal line opposite to said first seal line, said first chamber and said third chamber being in fluid communication with each other and isolated from said second chamber;
a heat storage/release material accommodated in said bag and flowing among said first chamber and said second chamber and said third chamber and adapted for storing/releasing heat energy;
a fixation device mounted on said bag and adapted to secure said bag in a folded condition where said first chamber and said third chamber are stacked up;
a first actuator formed of a metal strip and mounted in one of the first chamber and third chamber of said bag and bendable to generate microwaves for causing said heat storage/release material to produce a temperature rise and then to release heat for pre-heating scopes being set between said first chamber and said second chamber after said bag having been folded up; and
a second actuator formed of a metal strip and mounted in said second chamber of said bag and bendable to generate microwaves for causing said heat storage/release material to produce a temperature rise and then to release heat for pre-heating scopes being set between said first chamber and said second chamber after said bag having been folded up

12. The scopes heating device as claimed in claim 11, wherein said heat storage/release material is saturated sodium acetate solution.

13. The scopes heating device as claimed in claim 11, wherein said bag is made of a polymeric material.

14. The scopes heating device as claimed in claim 11, wherein said fixation device comprises:
a first fastening member provided at said bag corresponding to said first chamber; and
a second fastening member provided at said bag corresponding to said third chamber and fastenable to said first fastening member.

15. The scopes heating device as claimed in claim 14, wherein said first fastening member is a male fastening member, and said second fastening member is a female fastening member.

16. The scopes heating device as claimed in claim 15, wherein said bas has a first flap and a second flap respectively protruded from two opposite sides of one end thereof, said first fastening member and said second fastening member are respectively located on said first flap and said second flap.

17. The scopes heating device as claimed in claim 11, wherein said first seal line and said second seal line are longitudinally arranged in parallel; said third seal line is transversely connected between one end of said first seal line and one end of said second seal line.

18. The scopes heating device as claimed in claim 11, wherein said bag further has a fourth seal line transversely disposed in said second chamber and spaced between said first seal line and said second seal line remote from said third seal line and defining a space in said second chamber for accommodating said second actuator.

19. The scopes heating device as claimed in claim 16, wherein said first seal line, said second seal line and said flaps are made by means of a high-frequency heat sealing technique.

20. The scopes heating device as claimed in claim 11, wherein said bag further has a fifth seal line and a sixth seal line arranged at right angles around one corner of said third chamber remote from said fixation device and defining a fourth chamber in said bag for accommodating said first actuator; said fifth seal line and said sixth seal line are formed by means of a high-frequency heat sealing technique.
